(19) United States
(12) Patent Application Publication
(10) Pub. No.: US 2013/0200877 A1
(43) Pub. Date: Aug. 8, 2013

(54) GRADATION VOLTAGE GENERATING CIRCUIT AND LIQUID CRYSTAL DISPLAY DEVICE

(71) Applicant: FUNAI ELECTRIC CO., LTD., Osaka (JP)

(72) Inventor: Hitoshi NAKATSUKA, Osaka (JP)

(73) Assignee: FUNAI ELECTRIC CO., LTD., Osaka (JP)

(21) Appl. No.: 13/737,409

(22) Filed: Jan. 9, 2013

(30) Foreign Application Priority Data
Feb. 2, 2012 (JP) 2012-020468

(51) Int. Cl. G05F 3/16

(52) U.S. Cl. CPC G05F 3/16
USPC 323/313

(57) ABSTRACT

A gradation voltage generating circuit includes a resistor ladder circuit and a constant current circuit. The resistor ladder circuit has a plurality of resistors. The constant current circuit is electrically connected to the resistor ladder circuit. The constant current circuit is configured to supply a constant current to the resistor ladder circuit such that the resistor ladder circuit produces a plurality of reference potentials that is configured to be directly supplied to a source driver.

### CROSS-REFERENCE TO RELATED APPLICATIONS

This application claims priority to Japanese Patent Application No. 2012-020468 filed on Feb. 2, 2012. The entire disclosure of Japanese Patent Application No. 2012-020468 is hereby incorporated herein by reference.

### BACKGROUND

1. Field of the Invention

The present invention generally relates to a gradation voltage generating circuit. More specifically, the present invention relates to a gradation voltage generating circuit with a resistor ladder circuit. Furthermore, the present invention also relates to a liquid crystal display device.

2. Background Information

Gradation voltage generating circuits with a resistor ladder circuit have been conventionally known (see Japanese Laid-Open Patent Application Publication No. 2006-235368 (Patent Citation 1), for example).

The gradation voltage generating circuit, such as one discussed in the Patent Citation 1, includes a constant voltage generating circuit that supplies a constant output voltage, and an external resistor ladder circuit that is connected to the constant voltage generating circuit and uses a plurality of resistors to produce a plurality of reference potentials supplied to an LCD driver. With this gradation voltage generating circuit, the constant output voltage produced from power supply voltage by the constant voltage generating circuit is used to produce the reference potentials supplied to the LCD driver.

### SUMMARY

It has been discovered that with the gradation voltage generating circuit, if potentials of the power supply voltage and the output voltage are close to each other, the effect of fluctuation in the power supply voltage ends up causing the output voltage to fluctuate. Thus, this makes it, difficult to stably produce the reference potentials to be supplied to the source driver.

One object of the present disclosure is to provide a gradation voltage generating circuit with which a plurality of reference potentials supplied to a source driver can be produced stably.

In view of the state of the know technology, a gradation voltage generating circuit includes a resistor ladder circuit and a constant current circuit. The resistor ladder circuit has a plurality of resistors. The constant current circuit is electrically connected to the resistor ladder circuit. The constant current circuit is configured to supply a constant current to the resistor ladder circuit such that the resistor ladder circuit produces a plurality of reference potentials that is configured to be directly supplied to a source driver.

Other objects, features, aspects and advantages of the present disclosure will become apparent to those skilled in the art from the following detailed description, which, taken in conjunction with the annexed drawings, discloses a preferred embodiment of a gradation voltage generating circuit.

### BRIEF DESCRIPTION OF THE DRAWINGS

Referring now to the attached drawings which form a part of this original disclosure:

FIG. 1 is a block diagram of a liquid crystal television set in accordance with first to third embodiments;

FIG. 2 is a circuit diagram of an area around a gradation voltage generating circuit in the liquid crystal television set in accordance with the first embodiment;

FIG. 3 is a circuit diagram of a constant current circuit in the liquid crystal television set in accordance with the first embodiment;

FIG. 4 is a diagram illustrating a relation between gradation and applied voltage in the liquid crystal television set in accordance with the first embodiment;

FIG. 5 is a diagram illustrating a relation between transmissivity and applied voltage in the liquid crystal television set in accordance with the first embodiment;

FIG. 6 is a circuit diagram of resistors of a resistor ladder circuit and an area around internal resistors corresponding to a source driver in the liquid crystal television set in accordance with the first embodiment;

FIG. 7 is a diagram of a relation between error in combined resistance and error in internal resistance of the source driver;

FIG. 8 is a graph of the gamma characteristics at Rₙ₋₍ₙ₊₁₎/Rn≈1;

FIG. 9 is a graph of the gamma characteristics at Rₙ₋₍ₙ₊₁₎/Rn≈2;

FIG. 10 is a graph of the gamma characteristics at Rₙ₋₍ₙ₊₁₎/Rn≈4;

FIG. 11 is a circuit diagram of an area around a gradation voltage generating circuit in the liquid crystal television set in accordance with the second embodiment;

FIG. 12 is a circuit diagram of an area around a gradation voltage generating circuit in the liquid crystal television set in accordance with the third embodiment;

FIG. 13 is a circuit diagram of a constant current circuit in a liquid crystal television set in accordance with a modification example of the first embodiment; and

FIG. 14 is a circuit diagram of an area around a gradation voltage generating circuit in a liquid crystal television set in accordance with a modification example of the first to third embodiments.

### DETAILED DESCRIPTION OF EMBODIMENTS

Selected embodiments will now be explained with reference to the drawings. It will be apparent to those skilled in the art from this disclosure that the following descriptions of the embodiments are provided for illustration only and not for the purpose of limiting the invention as defined by the appended claims and their equivalents.

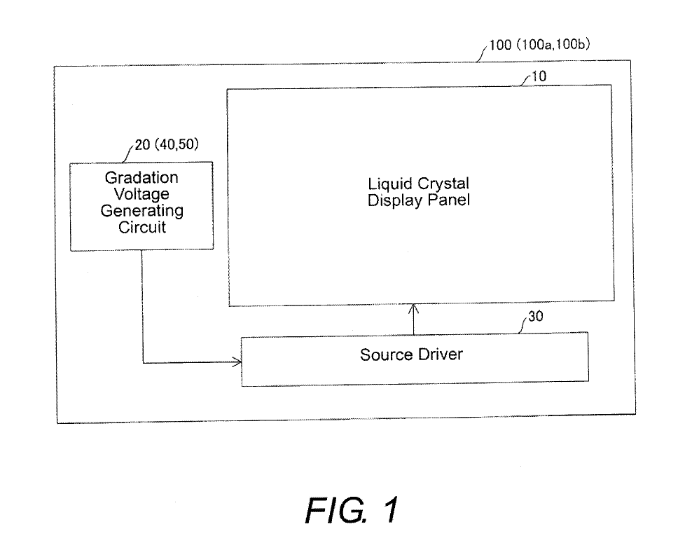

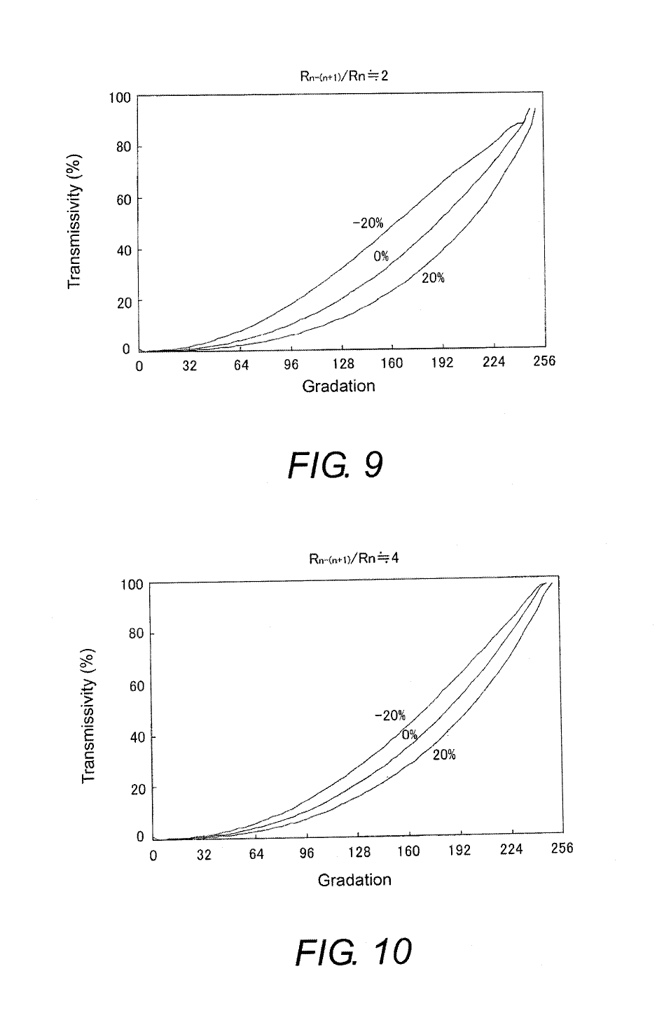

Referring to FIGS. 1 to 10, a liquid crystal television set 100 is illustrated in accordance with a first embodiment. The liquid crystal television set 100 is an example of the “liquid crystal display device” of the present application.

As shown in FIG. 1, the liquid crystal television set 100 includes a liquid crystal display panel 10, a gradation voltage generating circuit 20, and a source driver 30. The source driver 30 drives the liquid crystal display panel 10.

The liquid crystal display panel 10 is configured to display images. More specifically, the liquid crystal display panel 10 includes a plurality of pixels (not shown) arranged in a matrix. When gradation voltage is applied to these pixels, the transmissivity of light emitted from a backlight (not shown) is adjusted so that the desired colors are displayed by the various pixels. The liquid crystal display panel 10 is a normally-white type in which the transmissivity of light is approximately 100% (i.e., displaying in white) when no gradation voltage is being applied.

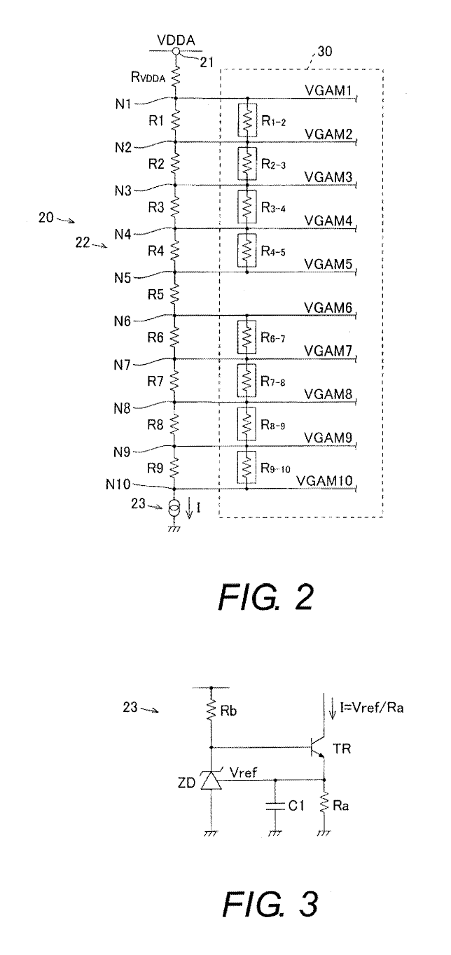

As shown in FIG. 2, the gradation voltage generating circuit 20 includes a power supply 21, a resistor ladder circuit 22, and a constant current circuit 23. The resistor ladder circuit 22 has resistors R_{VDDA}, R1, R2, R3, R4, R5, R6, R7, R8, and R9 that are connected in series. The constant current circuit 23 is electrically connected to the resistor ladder circuit 22.

The power supply 21 is connected to one end of the resistor R_{VDDA}. The power supply 21 has a voltage VDDA.

The resistor ladder circuit 22 is configured such that nodes N1 to N10 connected to the resistors R1 to R9 serve as output nodes, and reference potentials VGMA1 to VGMA10 are produced and directly supplied to the source driver 30. More specifically, the resistor ladder circuit 22 is configured such that the reference potentials VGMA1 to VGMA10 are produced by a voltage drop that occurs when a constant current I is supplied from the constant current circuit 23 to a combined resistance of the resistors R1 to R9 and internal resistors R₁₋₂, R₂₋₃, R₃₋₄, R₄₋₅, R₆₋₇, R₇₋₈, R₈₋₉, and R₉₋₁₀ of the source driver 30. In other words, the reference potentials VGMA1 to VGMA10 are produced by the voltage drop that occurs in response to the constant current circuit 23 supplying the constant current I to the combined resistance of the resistors R1 to R9 and internal resistors R₁₋₂, R₂₋₃, R₃₋₄, R₄₋₅, R₆₋₇, R₇₋₈, R₈₋₉, and R₉₋₁₀ of the source driver 30. The reference potential VGMA1 is the high voltage side, and the reference potential VGMA10 is the low voltage side. The reference potentials VGMA1 to VGMA5 are used as reference potentials on the positive electrode side, and the reference potentials VGMA6 to VGMA10 are used as reference potentials on the negative electrode side. The resistor ladder circuit 22 is also configured such that the reference potentials VGMA1 to VGMA10 are directly supplied to the source driver 30 without going through an op-amp or other such buffer. In other words, the resistor ladder circuit 22 is directly coupled to the source driver 30 without having a buffer or any other electrical component (except for wirings) therebetween.

In the illustrated embodiment, the constant current circuit 23 is configured such that the constant current I is supplied to the resistor ladder circuit 22. The constant current circuit 23 is connected at one end to the resistor R9 and at the other end to ground. That is, the constant current circuit 23 is connected to the low voltage side of the resistor ladder circuit 22. As shown in FIG. 3, the constant current circuit 23 has a shunt regulator ZD, resistors Ra and Rb, a capacitor C1, and a bipolar transistor TR. The shunt regulator ZD is grounded on the anode side of the input, and is connected on the cathode side of the input to the resistor Rb and the base of the bipolar transistor TR. The shunt regulator ZD is connected on the output side to one end of the capacitor C1, to one end of the resistor Ra, and to the emitter of the bipolar transistor TR. The other end of the capacitor C1 is grounded. The other end of the resistor Ra is grounded. The resistor Rb can be connected to a power supply for the constant current circuit 23. The collector of the bipolar transistor TR is connected to the resistor ladder circuit 22 (i.e., the resistor R9).

The constant current circuit 23 is configured such that the constant current I is produced by using a reference voltage Vref supplied from the output side of the shunt regulator ZD. That is, the constant current circuit 23 is configured so as to produce the constant current I expressed by the formula I=Vref/Ra. Also, the constant current circuit 23 is configured so that the value of the constant current I can be adjusted by adjusting the reference voltage Vref and/or the resistance of the resistor Ra. For example, when the constant current I is increased, the value of the reference voltage Vref is unchanged and the resistance of the resistor Ra is reduced to adjust the constant current I to the desired current value.

In the illustrated embodiment, the constant current circuit 23 is configured such that a current that is larger than when the resistors R1 to R4 and R6 to R9 of the resistor ladder circuit 22 and the internal resistors R₁₋₂ to R₄₋₅ and R₆₋₇ to R₉₋₁₀ have mutually equal resistance values is supplied to the combined resistance of the resistors R1 to R4 and R6 to R9 of the resistor ladder circuit 22 and the corresponding internal resistors R₁₋₂ to R₄₋₅ and R₆₋₇ to R₉₋₁₀ of the source driver 30. Consequently, even though the resistors R1 to R4 and R6 to R9 of the resistor ladder circuit 22 have resistance values that are lower than those of the corresponding internal resistors R₁₋₂ to R₄₋₅ and R₆₋₇ to R₉₋₁₀ of the source driver 30, respectively, the desired plurality of reference potentials VGMA1 to VGMA10 can be easily produced by the resistor ladder circuit 22 by adjusting the constant current I supplied by the constant current circuit 23.

The source driver 30 is configured so as to drive the liquid crystal display panel 10. More specifically, the source driver 30 is configured so as to apply gradation voltage to the various pixels of the liquid crystal display panel 10, based on the reference potentials VGMA1 to VGMA10 supplied from the gradation voltage generating circuit 20. Also, as shown in FIG. 2, the source driver 30 has the internal resistors R₁₋₂ to R₄₋₅ and R₆₋₇ to R₉₋₁₀. The internal resistors R₁₋₂ to R₄₋₅ and R₆₋₇ to R₉₋₁₀ are provided inside the source driver 30 so as to be connected in parallel with respect to the resistors R1 to R4 and R6 to R9 of the resistor ladder circuit 22, respectively.

Also, in the illustrated embodiment, the resistors R1 to R4 and R6 to R9 have a lower resistance value than the internal resistors R₁₋₂ to R₄₋₅ and R₆₋₇ to R₉₋₁₀, respectively. Therefore, when the respective ratios (Rₙ₋₍ₙ₊₁₎/Rn (where n is an integer of at least 1 and no more than 4, or at least 6 and no more than 9)) between the resistors R1 to R4 and R6 to R9 and the internal resistors R₁₋₂ to R₄₋₅ and R₆₋₇ to R₉₋₁₀ are increased, then it will be relatively difficult to increase the resistance value of the internal resistors Rₙ₋₍ₙ₊₁₎ of the source driver 30, while it will be easy to decrease the resistance value of the resistors Rn of the resistor ladder circuit 22. Thus, Rₙ₋₍ₙ₊₁₎/Rn can be easily increased by decreasing the resistance value of the resistors Rn.

Also, the ratios (Rₙ₋₍ₙ₊₁₎/Rn) between the resistance values of the resistors R1 to R4 and R6 to R9 and the internal resistors R₁₋₂ to R₄₋₅ and R₆₋₇ to R₉₋₁₀ are each preferably at least 2. It is even better for the ratios (Rₙ₋₍ₙ₊₁₎/Rn) between the resistance values of the resistors R1 to R4 and R6 to R9 and the internal resistors R₁₋₂ to R₄₋₅ and R₆₋₇ to R₉₋₁₀ each to be at least 4. This makes it possible to effectively diminish the effect of variance in the resistance values of the internal resistors R₁₋₂ to R₄₋₅ and R₆₋₇ to R₉₋₁₀ of the source driver 30.

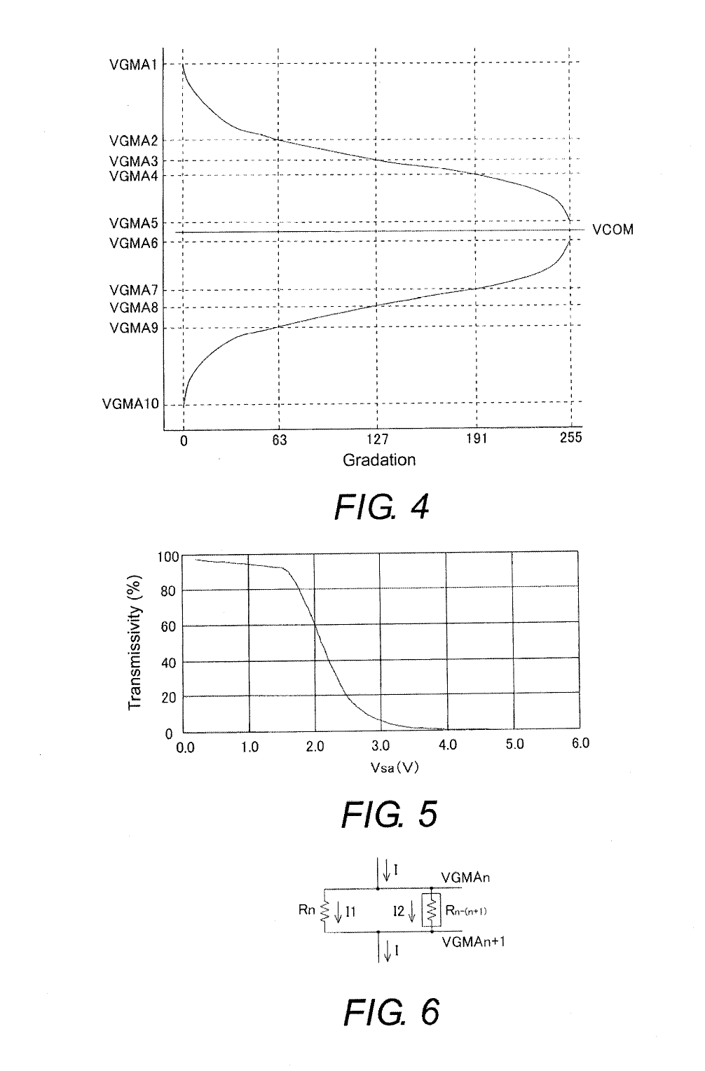

As shown in FIG. 4, the source driver 30 is configured such that gradation voltage on the positive electrode side and the negative electrode side around a common voltage VCOM is applied to the liquid crystal display panel 10. For example, if the gradation is zero, the source driver 30 is configured so that the reference potential VGMA1 is applied to the positive electrode side, and the reference potential VGMA10 to the negative electrode side. The relation between the absolute value Vsa of voltage applied to the liquid crystal display panel 10 and the transmissivity of light transmitted by the liquid crystal display panel 10 is shown by the curve in FIG. 5. The liquid crystal display panel 10 is a normally-white type in which transmissivity decreases as the absolute value Vsa of the applied voltage increases. The reference potentials VGMA1 to VGMA5 on the positive electrode side and the reference potentials VGMA6 to VGMA10 on the negative electrode side are set at potential locations that divide the 256 gradations into four equal parts so as to correspond to this curve. Also, the source driver 30 is configured so that the reference potentials VGMA1 to VGMA10 are further divided and gradation voltage corresponding to 256 gradations is applied to the liquid crystal display panel 10 (not shown).

Next, the change in gamma characteristics when the ratios between the internal resistors R₁₋₂ to R₄₋₅ and R₆₋₇ to R₉₋₁₀ of the source driver 30 and the resistors R1 to R4 and R6 to R9 of the resistor ladder circuit 22 are varied will be described through reference to FIGS. 6 to 10.

The resistors Rn (where n is an integer of at least I and no more than 4, or at least 6 and no more than 9) of the resistor ladder circuit 22 and the internal resistors Rₙ₋₍ₙ₊₁₎ of the source driver 30 are connected in parallel, respectively, as shown in FIG. 6. Also, current I1 is sent to the resistors Rn, while current I2 is sent to the internal resistors Rₙ₋₍ₙ₊₁₎. The constant current I is obtained by combining the current I1 flowing to the resistors Rn with the current I2 flowing to the internal resistors Rₙ₋₍ₙ₊₁₎.

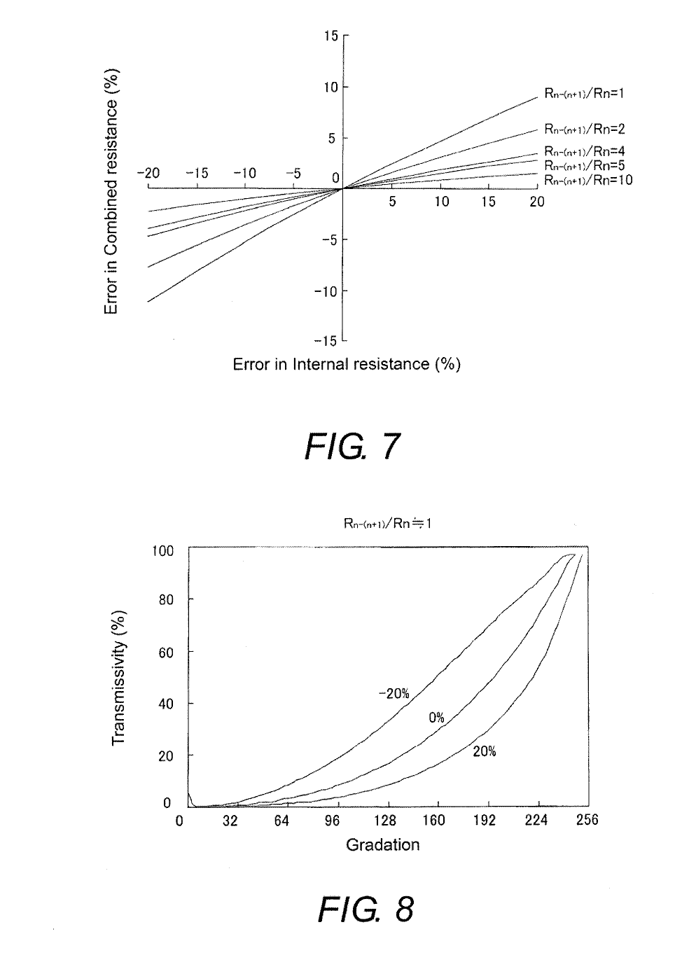

It is conceivable that the resistance values of the internal resistors Rₙ₋₍ₙ₊₁₎ of the source driver 30 will have variance from the design values. As shown in FIG. 7, the relation between variance (error) in the resistance values (e.g., internal resistance) of the internal resistors Rₙ₋₍ₙ₊₁₎ and variance (error) in the combined resistance of the resistors Rn and the internal resistors Rₙ₋₍ₙ₊₁₎ is such that variance (error) in the combined resistance decreases as the ratio between the resistance values of the resistors Rn and the internal resistors Rₙ₋₍ₙ₊₁₎ increases. Specifically, in the illustrated embodiment, variance (error) in the combined resistance of the resistors Rn and the internal resistors Rₙ₋₍ₙ₊₁₎ can be reduced by increasing the ratios (Rₙ₋₍ₙ₊₁₎/Rn) of the resistance values of the resistors Rn and the internal resistors Rₙ₋₍ₙ₊₁₎.

FIGS. 8 to 10 are graphs that show the change (effect) in gamma characteristics caused by variance (error) in the internal resistors Rₙ₋₍ₙ₊₁₎. FIGS. 8 to 10 show the gamma characteristics when the variance (error) in the internal resistors Rₙ₋₍ₙ₊₁₎ is −20%, 0% (design value), and 20%. As shown in FIGS. 8 to 10, as the ratios (Rₙ₋₍ₙ₊₁₎/Rn (≈1, 2, and 4)) of the resistance values between the resistors Rn and the internal resistors Rₙ₋₍ₙ₊₁₎ increase, the proportion by which the gamma characteristics when the variance (error) in Rₙ₋₍ₙ₊₁₎ is 20% or −20% change with respect to the gamma characteristics when the variance (error) in Rₙ₋₍ₙ₊₁₎ is 0% (design value) decreases. That is, the effect of variance (error) in the internal resistors Rₙ₋₍ₙ₊₁₎ can be reduced if the ratios (Rₙ₋₍ₙ₊₁₎/Rn) in the resistance values of the resistors Rn and the internal resistors Rₙ₋₍ₙ₊₁₎ are increased. Specifically, in the illustrated embodiment, it is possible to reduce fluctuations in the gamma characteristics by increasing the ratios (Rₙ₋₍ₙ₊₁₎/Rn) in the resistance values of the resistors Rn and the internal resistors Rₙ₋₍ₙ₊₁₎.

In the illustrated embodiment, as discussed above, because the constant current circuit 23 is provided for supplying the constant current I to the resistor ladder circuit 22, the effect of voltage fluctuations can be reduced as compared to when the plurality of reference potentials VGMA1 to VGMA10 are produced by supplying a specific voltage from a constant voltage generating circuit to the resistor ladder circuit 22. Thus, the plurality of reference potentials VGMA1 to VGMA10 that are supplied to the source driver 30 can be produced more stably. Also, since the resistor ladder circuit 22 is directly connected to the source driver 30 without going through an op-amp or other such buffer, there is no need for a buffer, and the circuit configuration can be correspondingly simplified.

Also, in the illustrated embodiment, as discussed above, the plurality of reference potentials VGMA1 to VGMA10 are produced by the voltage drop that occurs when the constant current is supplied from the constant current circuit 23 to the combined resistance of the resistors R1 to R4 and R6 to R9 of the resistor ladder circuit 22 and the internal resistors R₁₋₂ to R₄₋₅ and R₆₋₇ to R₉₋₁₀ provided to the source driver 30 so as to be connected in parallel with respect to the respective resistors R1 to R4 and R6 to R9 of the resistor ladder circuit 22. Furthermore, the resistors R1 to R4 and R6 to R9 of the resistor ladder circuit 22 have resistance values that are lower than those of the corresponding internal resistors R₁₋₂ to R₄₋₅ and R₆₋₇ to R₉₋₁₀ of the source driver 30. Consequently, the effect of error (variance) in the resistance values of the internal resistors R₁₋₂ to R₄₋₅ and R₆₋₇ to R₉₋₁₀ of the source driver 30 can be reduced. As a result, the plurality of reference potentials VGMA1 to VGMA10 supplied to the source driver 30 can easily be produced in a stable manner. Also, whereas increasing the resistance values of the internal resistors R₁₋₂ to R₄₋₅ and R₆₋₇ to R₉₋₁₀ of the source driver 30 is relatively difficult, decreasing the resistance values of the resistors R1 to R4 and R6 to R9 of the resistor ladder circuit 22 is easy. Thus, the effect of error (variance) in the resistance values of the internal resistors R₁₋₂ to R₄₋₅ and R₆₋₇ to R₉₋₁₀ of the source driver 30 can be easily reduced by decreasing the resistance values of the resistors R1 to R4 and R6 to R9 of the resistor ladder circuit 22. Also, since fluctuations in gradation voltage arising from error (variance) in the resistance values of the internal resistors R₁₋₂ to R₄₋₅ and R₆₋₇ to R₉₋₁₀ of the source driver 30 can be reduced, the brightness of the liquid crystal television set 100 according to specific gamma characteristics can be accurately controlled. Consequently, the image quality of the liquid crystal television set 100 can be enhanced.

Also, in the illustrated embodiment, as discussed above, since the constant current circuit 23 is connected to the low voltage side of the resistor ladder circuit 22, the current flowing to the shunt regulator ZD will not be added to the constant current that is produced, and the constant current I can flow correspondingly more stably to the resistor ladder circuit 22, than when the constant current circuit 23 is connected to the high voltage side of the resistor ladder circuit 22.

Also, in the illustrated embodiment, as discussed above, since the shunt regulator ZD is provided to the constant current circuit 23, the constant current I can be easily produced by using the shunt regulator ZD.

### Second Embodiment

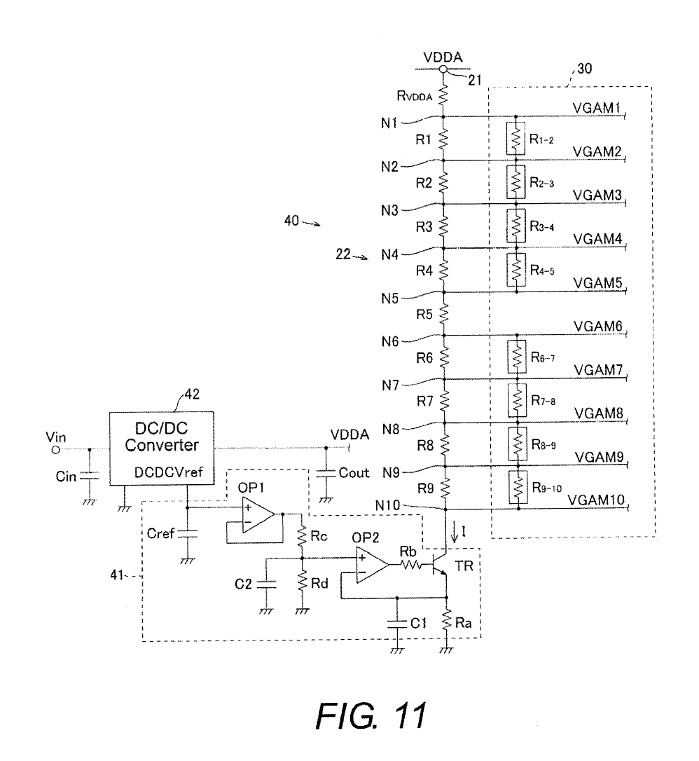

Referring now to FIGS. 1 and 11, a liquid crystal television set 100a in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

In the second embodiment, an example of a configuration will be described in which, unlike in the first embodiment above in which the constant current I is produced by the constant current circuit 23 by using the voltage of the shunt regulator ZD, instead the constant current I is produced by using reference voltage (e.g., supplied voltage) of a DC/DC converter 42. The liquid crystal television set 100a is an example of the “liquid crystal display device” of the present application. As shown in FIG. 1, the liquid crystal television set 100a includes the liquid crystal display panel 10, a gradation voltage generating circuit 40, and the source driver 30.

The gradation voltage generating circuit 40 of the liquid crystal television set 100a includes the power supply 21, the resistor ladder circuit 22, and a constant current circuit 41, as shown in FIG. 11. The constant current circuit 41 is electrically connected to the resistor ladder circuit 22.

In the illustrated embodiment, the constant current circuit 41 is configured so as to supply the constant current I to the resistor ladder circuit 22. The constant current circuit 41 is connected at one end to the resistor R9, and is grounded at the other end. That is, the constant current circuit 41 is connected to the low voltage side of the resistor ladder circuit 22. The constant current circuit 41 is also connected to the DC/DC converter 42. As shown in FIG. 11, the constant current circuit 41 has op-amps OP1 and OP2, resistors Ra to Rd, capacitors C1, C2, and Cref, and the bipolar transistor TR.

The op-amp OP1 is connected on the positive electrode side of the input to one end of the capacitor Cref and the reference voltage DCDCVref of the DC/DC converter 42, and is connected on the negative electrode side of the input to the output side of the op-amp OP1. The op-amp OP1 is also connected on the output side to one end of the resistor Rc. The op-amp OP2 is connected on the positive electrode side of the input to the other end of the resistor Rc, one end of the resistor Rd, and one end of the capacitor C2. The op-amp OP2 is also connected on the negative electrode side of the input to one end of the capacitor C1, one end of the resistor Ra, and the emitter of the bipolar transistor TR. The op-amp OP2 is also connected on the output side to the base of the bipolar transistor TR via the resistor Rb.

The other end of the capacitor Cref is grounded. The other end of the capacitor C1 is grounded. The other end of the capacitor C2 is grounded. The other end of the resistor Ra is grounded. The other end of the resistor Rd is grounded. The collector of the bipolar transistor TR is connected to the resistor ladder circuit 22 (i.e., the resistor R9).

The DC/DC converter 42 is configured so as to output the reference voltage DCDCVref (e.g., the supplied voltage) and the voltage VDDA by voltage conversion of the input voltage Vin. The DC/DC converter 42 is grounded. Also, the DC/DC converter 42 is connected on the input voltage Vin side to the other end of a capacitor Cin that is grounded at one end. The DC/DC converter 42 is connected on the voltage VDDA side to the other end of a capacitor Cout that is grounded at one end.

The constant current circuit 41 is configured so as to produce the constant current I by using the reference voltage DCDCVref of the DC/DC converter 42. Also, the constant current circuit 41 is configured so as to produce the constant current I, using as the reference voltage Vref a voltage that has been lowered by splitting with a resistance splitter the reference voltage DCDCVref supplied from the DC/DC converter 42 using the resistors Rc and Rd. That is, the constant current circuit 41 is configured so as to produce the constant current I expressed by the formula I=Vref/Ra. The constant current circuit 41 is also configured so that the current value of the constant current I can be adjusted by adjusting the reference voltage Vref and/or the resistor Ra. For example, when the constant current I is increased, the value of the reference voltage Vref is unchanged and the resistance of the resistor Ra is reduced to adjust the constant current I to the desired current value.

The rest of the configuration in the second embodiment is the same as that in the first embodiment above.

With the configuration of the illustrated embodiment, just as in the first embodiment above, because the constant current circuit 41 is provided to supply the constant current I to the resistor ladder circuit 22, the effect of voltage fluctuations can be reduced as compared to when the plurality of reference potentials VGMA1 to VGMA10 are produced by supplying a specific voltage from a constant voltage generating circuit to the resistor ladder circuit 22. Thus, the plurality of reference potentials VGMA1 to VGMA10 that are supplied to the source driver 30 can be produced more stably.

Furthermore, in the illustrated embodiment, as discussed above, the constant current circuit 41 is configured such that the voltage supplied from the DC/DC converter 42 is used to produce the constant current I. With this configuration, the constant current I can be produced by using the DC/DC converter 42 used for supplying power to other circuits. Thus, there is no need to provide a separate power supply for the constant current circuit 41.

Furthermore, in the illustrated embodiment, as discussed above, since the constant current circuit 41 is configured so as to produce the constant current I by using the reference voltage DCDCVref as the voltage supplied from the DC/DC converter 42, the constant current I can be easily produced by using the reference voltage DCDCVref as the voltage supplied from the DC/DC converter 42.

Also, in the illustrated embodiment, as discussed above, the constant current circuit 41 is configured so as to produce the constant current I using as the reference voltage Vref a voltage obtained by lowering the reference voltage DCDCVref supplied from the DC/DC converter 42. Thus, even if the reference voltage DCDCVref supplied from the DC/DC converter 42 is relatively high, the constant current I can be produced based on the desired reference voltage Vref. Therefore, the constant current circuit 41 can be easily connected to the low voltage side of the resistor ladder circuit 22.

Also, in the illustrated embodiment, as discussed above, the constant current circuit 41 includes the op-amps OP1 and OP2. With this configuration, the constant current I can be easily produced using the op-amps OP1 and OP2.

The other effects of the second embodiment are the same as those in the first embodiment above.

### Third Embodiment

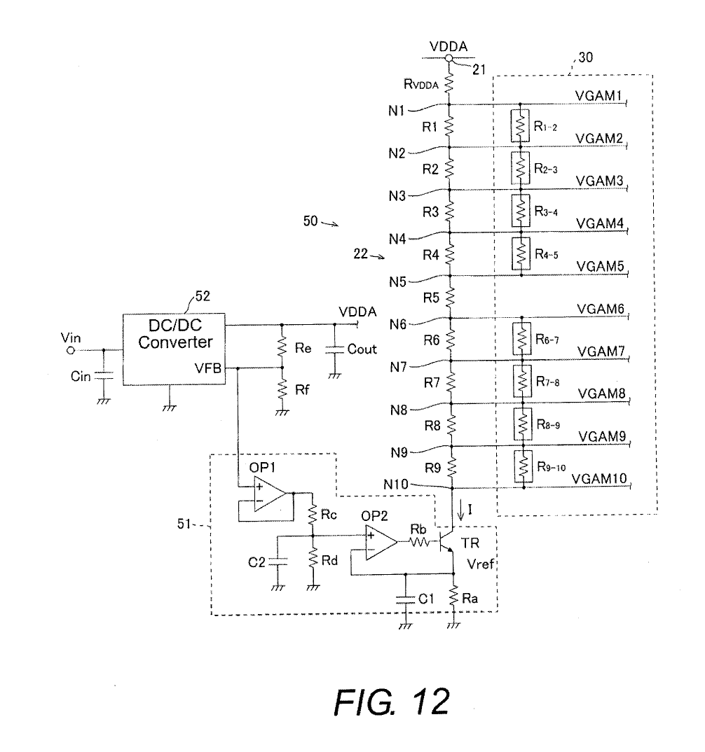

Referring now to FIGS. 1 and 12, a liquid crystal television set 100b in accordance with a third embodiment will now be explained. In view of the similarity between the first and third embodiments, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

In the third embodiment, an example of a configuration will be described in which, unlike in the first embodiment above in which the constant current I is produced by the constant current circuit 23 by using the voltage of the shunt regulator ZD, instead the constant current I is produced by using feedback voltage (e.g., supplied voltage) of a DC/DC converter 52. The liquid crystal television set 100b is an example of the “liquid crystal display device” of the present application. As shown in FIG. 1, the liquid crystal television set 100b includes the liquid crystal display panel 10, a gradation voltage generating circuit 50, and the source driver 30.

The gradation voltage generating circuit 50 of the liquid crystal television set 100b includes the power supply 21, the resistor ladder circuit 22, and a constant current circuit 51, as shown in FIG. 12. The constant current circuit 51 is electrically connected to the resistor ladder circuit 22.

In the illustrated embodiment, the constant current circuit 51 is configured so as to supply the constant current I to the resistor ladder circuit 22. The constant current circuit 51 is connected at one end to the resistor R9, and is grounded at the other end. That is, the constant current circuit 51 is connected to the low voltage side of the resistor ladder circuit 22. The constant current circuit 51 is also connected to a DC/DC converter 52. As shown in FIG. 12, the constant current circuit 51 has op-amps OP1 and OP2, resistors Ra to Rd, capacitors C1 and C2, and the bipolar transistor TR.

The op-amp OP1 is connected on the positive electrode side of the input to one end of the resistor Re, one end of the resistor Rf, and feedback voltage VFB of the DC/DC converter 52, and is connected on the negative electrode side of the input to the output side of the op-amp OP1. The op-amp OP1 is also connected on the output side to one end of the resistor Rc. The op-amp OP2 is connected on the positive electrode side of the input to the other end of the resistor Rc, one end of the resistor Rd, and one end of the capacitor C2. The op-amp OP2 is also connected on the negative electrode side of the input to one end of the capacitor C1, one end of the resistor Ra, and the emitter of the bipolar transistor TR. The op-amp OP2 is also connected on the output side to the base of the bipolar transistor TR via the resistor Rb.

The other end of the capacitor C1 is grounded. The other end of the capacitor C2 is grounded. The other end of the resistor Ra is grounded. The other end of the resistor Rd is grounded. The collector of the bipolar transistor TR is connected to the resistor ladder circuit 22 (i.e., the resistor R9).

The DC/DC converter 52 is configured so as to output the feedback voltage VFB (a voltage obtained by feedback to the DC/DC converter 52 of the voltage outputted from the DC/DC converter 52 to the voltage VDDA) and the voltage VDDA by voltage conversion of the input voltage Vin. The DC/DC converter 52 is grounded. Also, the DC/DC converter 52 is connected on the input voltage Vin side to the other end of a capacitor Cin that is grounded at one end. The DC/DC converter 52 is connected on the voltage VDDA side to the other end of the resistor Re and to the other end of a capacitor Cout that is grounded at one end. Consequently, even if no reference voltage Vref terminal is provided to the DC/DC converter 52, the constant current I can be produced by using the feedback voltage VFB.

The constant current circuit 51 is configured so as to produce the constant current I by using the feedback voltage VFB (e.g., the supplied voltage) of the DC/DC converter 52. Also, the constant current circuit 51 is configured so as to produce the constant current I, using as the reference voltage Vref a voltage that has been lowered by splitting with a resistance splitter the feedback voltage VFB supplied from the DC/DC converter 52 using the resistors Rc and Rd. That is, the constant current circuit 51 is configured so as to produce the constant current I expressed by the formula I=Vref/Ra. The constant current circuit 51 is also configured so that the current value of the constant current I can be adjusted by adjusting the reference voltage Vref and/or the resistor Ra. For example, when the constant current I is increased, the value of the reference voltage Vref is unchanged and the resistance of the resistor Ra is reduced to adjust the constant current I to the desired current value.

The rest of the configuration in the third embodiment is the same as that in the first embodiment above.

With the configuration of the illustrated embodiment, just as in the first embodiment above, because the constant current circuit 51 is provided to supply the constant current I to the resistor ladder circuit 22, the effect of voltage fluctuations can be reduced as compared to when the plurality of reference potentials VGMA1 to VGMA10 are produced by supplying a specific voltage from a constant voltage generating circuit to the resistor ladder circuit 22. Thus, the plurality of reference potentials VGMA1 to VGMA10 that are supplied to the source driver 30 can be produced more stably.

Furthermore, in the illustrated embodiment, as discussed above, the constant current circuit 51 is configured such that the voltage supplied from the DC/DC converter 52 is used to produce the constant current I. With this configuration, the constant current I can be produced by using the DC/DC converter 52 used for supplying power to other circuits. Thus, there is no need to provide a separate power supply for the constant current circuit 51.

Furthermore, in the illustrated embodiment, as discussed above, since the constant current circuit 51 is configured so as to produce the constant current I by using the feedback voltage VFB as the voltage supplied from the DC/DC converter 52, the constant current I can be easily produced by using the feedback voltage VFB as the voltage supplied from the DC/DC converter 52.

Also, in the illustrated embodiment, as discussed above, the constant current circuit 51 includes the op-amps OP1 and OP2. With this configuration, the constant current I can be easily produced using the op-amps OP1 and OP2.

The other effects of the third embodiment are the same as those in the first embodiment above.

The foregoing descriptions of the embodiments according to the present invention are provided for illustration only, and not for the purpose of limiting the invention as defined by the appended claims and their equivalents. It will be apparent to those skilled in the art from this disclosure that various changes and modifications can be made herein without departing from the scope of the invention as defined in the appended claims.

For example, in the first to third embodiments above, the liquid crystal television sets 100, 100a and 100b are illustrated as an example of the gradation voltage generating circuit of the present application. However, the present application is not limited to this. The present application can also be applied to liquid crystal display devices other than liquid crystal television sets, or to display devices other than liquid crystal display devices. For instance, the present application can be applied to the liquid crystal display of a personal computer, or the like.

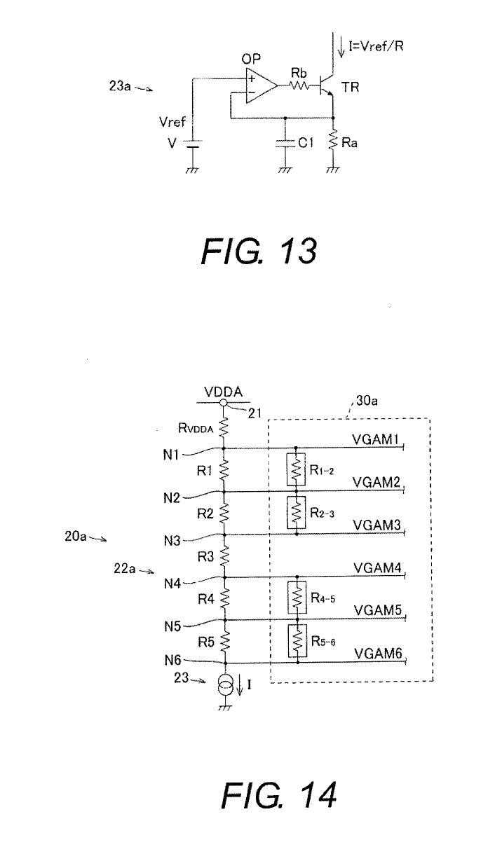

In the first embodiment above, the constant current circuit 23 includes the shunt regulator ZD. However, the present application is not limited to this. With the present application, the configuration of a constant current circuit 23a can include an op-amp OP, resistors Ra and Rb, a capacitor C1, a bipolar transistor TR, and a voltage circuit V, as in the modification example of the first embodiment shown in FIG. 13. In this case, the op-amp OP is connected on the positive electrode side of the input to the voltage circuit V, and on the negative electrode side of the input to one end of the capacitor C1, one end of the resistor Ra, and the emitter of the bipolar transistor TR. Also, the op-amp OP is connected on the output side to the base of the bipolar transistor TR via the resistor Rb. The other end of the capacitor C1 is grounded. The other end of the resistor Ra is grounded. The collector of the bipolar transistor TR is connected to the resistor ladder circuit 22 (i.e., the resistor R9). The voltage circuit V is configured so as to output the reference voltage Vref. The constant current circuit 23a is configured so as to produce the constant current I expressed by the formula I=Vref/Ra.

In the first to third embodiments above, the gradation voltage generating circuits 20, 40 and 50 supply 10 types of reference potentials to the source driver 30. However, the present application is not limited to this. With the present application, the gradation voltage generating circuit can be configured to supply nine or fewer types of reference potentials to the source driver, or the gradation voltage generating circuit can be configured to supply 11 or more types of reference potentials to the source driver. For example, when the gradation voltage generating circuit 20a supplies six types of reference potentials to a source driver 30a, as shown in FIG. 14, the gradation voltage generating circuit 20a includes the power supply 21, a resistor ladder circuit 22a, and the constant current circuit 23. The resistor ladder circuit 22a has resistors R_{VDDA}, R1, R2, R3, R4, and R5 connected in series. Internal resistors R₁₋₂ to R₄₋₅ and R₆₋₇ to R₉₋₁₀ of the source driver 30a are respectively connected in parallel with respect to the resistors R1, R2, R4, and R5 of the resistor ladder circuit 22a. Also, the resistor ladder circuit 22a is configured so as to produce reference potentials VGMA1 to VGMA6 supplied to the source driver 30a, using nodes N1 to N6 connected to the resistors R1 to R5 as output nodes. Consequently, the gradation voltage generating circuit 20a will take up less space than when the gradation voltage generating circuit supplies seven or more types of reference potentials to the source driver 30a. Also, the bus line can be reduced by reducing the types of reference potentials of the gradation voltage generating circuit. Thus, the bus line will take up less space.

In the first to third embodiments above, the constant current circuit includes a shunt regulator or an op-amp. However, the present application is not limited to this. With the present application, the constant current circuit need not include a shunt regulator or an op-amp, so long as a constant current can be supplied to the resistor ladder circuit.

In the first to third embodiments above, the constant current circuit is connected to the low voltage side of the resistor ladder circuit. However, the present application is not limited to this. With the present application, the constant current circuit can be connected between the high voltage side and the low voltage side of the resistor ladder circuit, or can be connected to the high voltage side of the resistor ladder circuit, so long as a constant current can be supplied to the resistor ladder circuit.

In the first to third embodiments above, the liquid crystal display panel 10 is a normally-white type in which the transmissivity of light is approximately 100% (i.e., displaying in white) when no gradation voltage is being applied. However, the present application is not limited to this. With the present application, the liquid crystal display panel 10 can be a normally-black type in which the transmissivity of light is approximately 0% (i.e., displaying in black) when no gradation voltage is being applied.

In the first to third embodiments above, one source driver is connected to the gradation voltage generating circuit. However, the present application is not limited to this. With the present application, a plurality of source drivers can be connected to the gradation voltage generating circuit. Furthermore, when a plurality of source drivers are connected in parallel to each other, the configuration can be such that a constant current is supplied to the combined resistance of the individual resistors of the resistor ladder circuit and the corresponding internal resistors of the plurality of source drivers.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A gradation voltage generating circuit comprising:
a resistor ladder circuit having a plurality of resistors; and
a constant current circuit electrically connected to the resistor ladder circuit, the constant current circuit being configured to supply a constant current to the resistor ladder circuit such that the resistor ladder circuit produces a plurality of reference potentials that is configured to be directly supplied to a source driver.

2. The gradation voltage generating circuit according to claim 1, wherein
the resistor ladder circuit is configured to produce the reference potentials by voltage drop that occurs in response to the constant current circuit supplying the constant current to a combined resistance of the resistors of the resistor ladder circuit and internal resistors of the source driver that are connected in parallel with respect to the resistors of the resistor ladder circuit, respectively, the resistors of the resistor ladder circuit having resistance values that are lower than those of the corresponding internal resistors of the source driver.

3. The gradation voltage generating circuit according to claim 1, wherein
the constant current circuit is configured to produce the constant current based on supplied voltage that is supplied from a DC/DC converter.

4. The gradation voltage generating circuit according to claim 3, wherein
the constant current circuit is configured to produce the constant current by using one of feedback voltage and reference voltage that is supplied from the DC/DC converter as the supplied voltage.

5. The gradation voltage generating circuit according to claim 3, wherein
the constant current circuit is configured to produce the constant current based on voltage that is obtained by lowering the supplied voltage that is supplied from the DC/DC converter.

6. The gradation voltage generating circuit according to claim 1, wherein
the constant current circuit is connected to a low voltage side of the resistor ladder circuit.

7. The gradation voltage generating circuit according to claim 1, wherein
the constant current circuit includes a shunt regulator.

8. The gradation voltage generating circuit according to claim 1, wherein
the constant current circuit includes an op-amp.

9. The gradation voltage generating circuit according to claim 1, wherein
the resistor ladder circuit is configured to be directly coupled to the source driver without having a buffer therebetween.

10. A liquid crystal display device comprising:
a liquid crystal display panel;
a source driver configured to drive the liquid crystal display panel; and
a gradation voltage generating circuit including
a resistor ladder circuit having a plurality of resistors, and
a constant current circuit electrically connected to the resistor ladder circuit, the constant current circuit being configured to supply a constant current to the resistor ladder circuit such that the resistor ladder circuit produces a plurality of reference potentials that is directly supplied to the source driver.

11. The liquid crystal display device according to claim 10, wherein
the resistor ladder circuit is configured to produce the reference potentials by voltage drop that occurs in response to the constant current circuit supplying the constant current to a combined resistance of the resistors of the resistor ladder circuit and internal resistors of the source driver that are connected in parallel with respect to the resistors of the resistor ladder circuit, respectively, the resistors of the resistor ladder circuit having resistance values that are lower than those of the corresponding internal resistors of the source driver.

12. The liquid crystal display device according to claim 10, further comprising
a DC/DC converter configured to supply supplied voltage to the constant current circuit,
the constant current circuit being configured to produce the constant current based on the supplied voltage.

13. The liquid crystal display device according to claim 12, wherein
the constant current circuit is configured to produce the constant current based on one of feedback voltage and reference voltage that is supplied from the DC/DC converter as the supplied voltage.

14. The liquid crystal display device according to claim 12, wherein
the constant current circuit is configured to produce the constant current based on voltage that is obtained by lowering the supplied voltage that is supplied from the DC/DC converter.

15. The liquid crystal display device according to claim 10, wherein
the resistor ladder circuit is directly coupled to the source driver without having a buffer therebetween.
